(19) United States
(12) Patent Application Publication
(10) Pub. No.: US 2004/0199781 A1
(43) Pub. Date: Oct. 7, 2004

(54) Data source privacy screening systems and methods

(76) Inventors: Lars Carl Erickson, Newtonville, MA (US); Agneta Breitenstein, Somerville, MA (US); Don Pettini, Ando, MA (US)

Correspondence Address: ROPES & GRAY LLP, ONE INTERNATIONAL PLACE, BOSTON, MA, 02110-2624, US

(21) Appl. No.: 10/232,772

(22) Filed: Aug. 30, 2002

Related U.S. Application Data
(60) Provisional application No. 60/315,751, filed on Aug. 30, 2001.
(60) Provisional application No. 60/315,753, filed on Aug. 30, 2001.
(60) Provisional application No. 60/315,754, filed on Aug. 30, 2001.
(60) Provisional application No. 60/315,755, filed on Aug. 30, 2001.
(60) Provisional application No. 60/335,787, filed on Dec. 5, 2001.

(51) Int. Cl. G06F 11/30

(52) U.S. Cl. 713/200

(57) ABSTRACT

A de-identification method and an apparatus for performing same on electronic datasets are described. The method and system processes input datasets or databases that contain records relating to individual entities to produce a resulting output dataset that contains as much information as possible while minimizing the risk that any individual in the input dataset could be re-identified from that output dataset. Individual entities may include patients in a hospital or served by an insurance carrier, as well as voters, subscribers, customers, companies, or any other organization of discrete records. Criteria for preventing re-identification can be selected based on intended use of the output data and can be adjusted based on the content of reference databases. The method and system can also be associated with data acquisition equipment, such as a biologic data sampling device, to prevent de-identification of patient or other confidential data acquired by the equipment.

### CROSS-REFERENCE(S) TO RELATED APPLICATIONS

This application claims the benefit of U.S. Provisional Applications Nos. 60/315751, 60/315753, 60/315754, and 60/315755, all filed on 30 Aug. 2001, and No. 60/335787, filed on 5 Dec. 2001, hereby incorporated herein by reference in their entireties.

### BACKGROUND OF THE INVENTION

1. Field of the Invention

The invention relates to data processing and in particular to privacy assurance and data de-identification methods, with application to the statistical and bioinformatic arts.

2. Description of the Related Art

There presently exist regulatory limits on the circumstances under which information about individuals can be collected and disseminated. These regulations are both broadly based and international in scope, such as the “European Union Directive on Data Protection” (EU Directive 95/46/EC) as well as tailored to specific individuals in specific circumstances. An example of the latter is the recently-enacted “Health Insurance Portability and Accountability Act” (HIPAA) in the United States that restricts patient information disclosure in the health care setting. These new rules, coupled with the generalized desire for privacy expressed, oft-times vehemently, by the public, create a real need for enhanced privacy systems.

As one example, physicians, hospitals, and pharmacies that provide information about health care delivery must ensure the privacy of individual patients in accordance with both the new laws and the patients' own demands. There are currently known in the art at least two methods of “anonymizing” (or obscuring the individually identifying aspects) or such data. The first is field-based de-identification, in which various data fields within each patient record are completely eliminated. Elimination of these individually-identifying fields, e.g., name, Social Security Number, street address, by record truncation reduces the risk of re-identification by comparing or linking the remaining fields with outside data sources, such as Census data or voter registry files.

This first approach has at least two drawbacks: much of the most useful data (from the database user or researcher's viewpoint) gets eliminated and there still exists a real risk of re-identification. For example, given the full date of birth, gender, and residential Zip code only, one can re-identify about 65 to 80% of the subjects of a dataset by comparing or cross-linking that dataset to a local voter registry or motor vehicle registration and/or license database for the listed Zip Codes. And even if the date of birth fields were truncated to only the year of birth, a number of individuals who were very old or living in low-population Zip code areas would still be re-identified.

The second anonymization method known in the art is based on record-based scrubbing algorithms. These algorithms seek to ensure that no record is unique in a dataset by deleting or truncating field values in individual records. This approach is based on the well-known k-anonymity concept. K-anonymity states that for every unique record there must be a total of at least k records with exactly the same field values. Presently-known k-anonymity algorithms focus on reduction on the overall number of fields truncated.

K-anonymity algorithms have two substantial drawbacks. First, few data users (researchers) can tolerate having the data altered in a seemingly random fashion according to these algorithms. Some fields are necessarily more critical to a particular line of research inquiry than others. Additionally, the k-anonymity algorithms require computation resources and times that do not scale to the needs of large-scale, industrial data users and researchers.

What is needed is a de-identification system that is computationally compact, scaleable, and able to specify which fields are to be preserved (i.e., not truncated) or, conversely, which fields may be sacrificed in the interests of anonymization.

### SUMMARY

A de-identification method and an apparatus for performing same on electronic datasets are described. In one embodiment, the system processes datasets (also referred to generally as databases) input to the system by an operator and containing records relating to individual entities to produce a resulting (output) dataset that contains as much information as possible while minimizing the risk that any individual in the dataset could be re-identified from that output dataset. Individual entities may include patients in a hospital or served by an insurance carrier, voters, subscribers, customers, companies, or any other organization of discrete records. Each such record contains one or more fields and each field can take on a respective value. Output dataset quality, i.e., its information content level, is determined by the system operator, who prioritizes the fields according to the ones having the highest value to the end-user. Here, the term “end-user” may be understood as, although not limited to, referring to the person who will receive the de-identified, output dataset and conduct research thereon without reference to the input dataset or datasets. The end-user may be distinguished from the operator by the fact that the operator has access to the un-scrubbed, raw input datasets while the end-user does not.

The de-identification system and method may also include tools that allow the operator to manipulate or filter the input dataset, convert the format of the input data (as, for example, by row column transpose or normalization), measure the risk of de-identification before and after processing, and provide intermediate statistical measures of data quality.

Truncated filed value data may be deleted outright in the output dataset or it may be placed into the output dataset in an encrypted form. The latter embodiment preserves the truncated filed value data in the output, but renders it inaccessible to those lacking the proper encryption keys. A flag or other means well-known in the art can be used in connection with a truncated field so encrypted to mark it for exclusion from statistical analysis.

The de-identification system may also be employed in conjunction with sampling devices. In such an embodiment, the de-identification system processes record-level data as it is collected from a measurement or sensing instrument, for example a biologic sampling device such as the DNA array “biochip” well-known in the art. The system aggregates the results of multiple samples and outputs the minimum amount of data allowable for the pre-selected level of de-identification.

The de-identification system may also be used in a “streaming” mode, by continuously maintaining and updating a table of unique records from a stream of data supplied overtime. This table also includes a count of the number of occurrences of each unique record identified within the input stream. By tallying the various unique record identifiers (such as unique person identifiers), within a collection of otherwise unique records, the system may enable the truncation (by deletion or encryption) of the information necessary for de-identification of a given record within the collection of data that has streamed through in a particular time window. Furthermore, based on dynamic measure of uniqueness, the system can optionally be configured to decrypt data previously truncated by encryption when the relative uniqueness of that data drops.

### BRIEF DESCRIPTION OF THE DRAWINGS

The present disclosure may be better understood and its numerous features and advantages made apparent to those skilled in the art by referencing the accompanying drawings.

FIG. 1 is a schematic process flow according to one embodiment of the invention; and

FIG. 2 is a schematic process flow according to another embodiment of the invention using a reference database; and

FIG. 3 is a screen shot of a user login screen.

The use of the same reference symbols in different drawings indicates similar or identical items.

### DETAILED DESCRIPTION OF CERTAIN ILLUSTRATED EMBODIMENTS

The systems and methods described herein include, among other things, systems and methods that employ a k-anonymity analysis of abstract to produce a new data set that protects patient privacy, while providing as much information as possible from the original data set. The premise of k-anonymity is that given a number k, every unique record, such as a patient in a medical setting, in a dataset will have at least k identical records. Sweeney, L. “Protecting privacy when disclosing information: k-anonymity and its enforcement through generalization and suppression” (with Pierangela Samarati), Proceedings of the IEEE Symposium on Research in Security and Privacy, May 1998, Oakland, Calif.; Sweeney, L. Datafly: a system for providing anonymity in medical data. Database Security XI: Status and Prospects, T. Y. Lin and S. Qian, eds. IEEE, IFIP. New York: Chapman & Hall, 1998; Sweeney, L. Comnputational Disclosure Control: A Primer on Data Privacy Protection, (Ph.D. thesis, Massachusetts Institute of Technology), August, 2001. Available on the Internet in draft form at http://www.swiss.ai.mit.edu/classes/6.805/articies/privacy/sweeney-thesis-draft.pdf. Conventional algorithms, like those disclosed in the references above, do not give a priority or rank to a record fields, meaning that all record fields are treated equally. However, it can be expected that certain fields are more important to an end user than others. For example, a drug manufacturer may be more interested in the gender or age distribution of certain diagnoses or findings than in a geographic distribution.

The following example describes a process algorithm that will identify fields within individual records that, if deleted (“scrubbed”), will result in k-anonymity for that dataset, but will have the additional feature that fields are ranked by their perceived or expected importance and that those fields with the greatest importance will be scrubbed the least.

An exemplary input dataset

| | Sex | Age Decade | Zip 3 |
|---|---|---|---|
| Record | 1 | 2 | 3 |
| 1 | M | 30 | 022 |
| 2 | M | 50 | 021 |
| 3 | M | 30 | 021 |
| 4 | M | 40 | 021 |
| 5 | F | 30 | 021 |
| 6 | F | 30 | 022 |
| 6 | F | 30 | 022 |
| 7 | M | 30 | 022 |
| 8 | M | 40 | 021 |
| 9 | F | 40 | 022 |
| 10 | M | 40 | 022 |
| 11 | F | 20 | 021 |
| 12 | M | 30 | 021 |
| 13 | F | 20 | 022 |
| 14 | M | 30 | 022 |
| 15 | M | 20 | 022 |
| 16 | F | 30 | 021 |
| 17 | F | 20 | 021 |
| 18 | F | 40 | 022 |
| 19 | M | 20 | 021 |
| 20 | U | 30 | 023 |

is first ranked (e.g. Sex first, followed by Age Decade and three-digit Zip Code prefix) and then sorted according to their rank, resulting in the modified data source below:

| | Sex | Age Decade | Zip 3 |
|---|---|---|---|
| Record | 1 | 2 | 3 |
| 11 | F | 20 | 021 |
| 17 | F | 20 | 021 |
| 5 | F | 20 | 021 |
| 13 | F | 20 | 022 |
| 16 | F | 30 | 021 |
| 6 | F | 30 | 022 |
| 6 | F | 30 | 022 |
| 9 | F | 40 | 022 |
| 18 | F | 40 | 022 |
| 19 | M | 20 | 021 |
| 15 | M | 20 | 022 |
| 3 | M | 30 | 021 |
| 12 | M | 30 | 021 |
| 1 | M | 30 | 022 |
| 7 | M | 30 | 022 |
| 14 | M | 30 | 022 |
| 4 | M | 40 | 021 |
| 8 | M | 40 | 021 |
| 10 | M | 40 | 022 |
| 2 | M | 50 | 021 |
| 20 | U | 30 | 023 |

Each of the unique values in the first field (Sex) is then examined, and those first fields occurring with a frequency of less than k (k=3 was selected above) are “scrubbed.” Note that duplicate records for patient 6 are only counted once.

| | Sex | |
|---|---|---|
| Record | 1 | |
| 11 | F | (8 ≧ k) note |
| 17 | F | that the two |
| 13 | F | records for |
| 5 | F | patient 6 are |
| 16 | F | only counted |
| 6 | F | once |
| 6 | F | |
| 9 | F | |
| 18 | F | |
| 19 | M | (11 ≧ k) |
| 15 | M | |
| 3 | M | |
| 12 | M | |
| 1 | M | |
| 7 | M | |
| 14 | M | |
| 4 | M | |
| 8 | M | |
| 10 | M | |
| 2 | M | |
| 20 | U | (1 < k) |

Next, within each unique value for the first field, each of the unique values in the second field is examined, and again those occurring with a frequency of less than k=3 are “scrubbed.” Again, the two records for patient 6 only counted once. The symbol “*” represents a field scrubbed in the prior iteration.

| | Sex | Age Decade | |
|---|---|---|---|
| Record | 1 | 2 | |
| 11 | F | 20 | (4 ≧ k) |
| 17 | F | 20 | |
| 13 | F | 20 | |
| 5 | F | 20 | |
| 16 | F | 30 | (2 < k) |
| 6 | F | 30 | |
| 6 | F | 30 | |
| 9 | F | 40 | (2 < k) |
| 18 | F | 40 | |
| 19 | M | 20 | (2 < k) |
| 15 | M | 20 | |
| 3 | M | 30 | (5 ≧ k) |
| 12 | M | 30 | |
| 1 | M | 30 | |
| 7 | M | 30 | |
| 14 | M | 30 | |
| 4 | M | 40 | (3 ≧ k) |
| 8 | M | 40 | |
| 10 | M | 40 | |
| 2 | M | 50 | (1 < k) |
| 20 | * | 30 | (1 < k) |

And so again for the next field:

| | Sex | Age Decade | Zip 3 | |
|---|---|---|---|---|
| Patient | 1 | 2 | 3 | |
| 11 | F | 20 | 021 | (3 ≧ k) |
| 17 | F | 20 | 021 | |
| 5 | F | 20 | 021 | |
| 13 | F | 20 | 022 | (1 < k) |
| 16 | F | * | 021 | (1 < k) |
| 6 | F | * | 022 | |
| 6 | F | * | 022 | (4 ≧ k) |
| 9 | F | * | 022 | |
| 18 | F | * | 022 | |
| 3 | M | 30 | 021 | (2 < k) |
| 12 | M | 30 | 021 | |
| 1 | M | 30 | 022 | (3 ≧ k) |
| 7 | M | 30 | 022 | |
| 14 | M | 30 | 022 | |
| 4 | M | 40 | 021 | (2 < k) |
| 8 | M | 40 | 021 | |
| 10 | M | 40 | 022 | (1 < k) |
| 19 | M | * | 021 | (2 < k) |
| 2 | M | * | 021 | |
| 15 | M | * | 022 | (1 < k) |
| 20 | * | * | 023 | (1 < k) |

resulting in this final scrubbed database:

| | Sex | Age Decade | Zip 3 |
|---|---|---|---|
| Record | 1 | 2 | 3 |
| 11 | F | 20 | 021 |
| 17 | F | 20 | 021 |
| 5 | F | 20 | 021 |
| 13 | F | 20 | * |
| 16 | F | * | * |
| 6 | F | * | 022 |
| 9 | F | * | 022 |
| 18 | F | * | 022 |
| 3 | M | 30 | * |
| 12 | M | 30 | * |
| 1 | M | 30 | 022 |
| 7 | M | 30 | 022 |
| 14 | M | 30 | 022 |
| 4 | M | 40 | * |
| 8 | M | 40 | * |
| 10 | M | 40 | * |
| 19 | M | * | * |
| 2 | M | * | * |
| 15 | M | * | * |
| 20 | * | * | * |

As a rule, the best-ranked fields will be the ones scrubbed the least, as will fields with fewer unique values. The above example results in the statistics below:

| | Unique | Fraction | Data |
|---|---|---|---|
| | Values | Scrubbed | Retained |
| Sex | 3 | 5% | 95% |
| Age Decade | 3 | 38% | 62% |
| Zip 3 | 3 | 52% | 48% |
| Total | | 33% | 67% |

As mentioned above, there were two entries for the same person (identifier #6). Records with multiple occurrences belonging to a single person can be more easily identifiable. Consequently, not just the number of occurrences of a unique record may be tallied, but also the number of unique people associated with it, as is done in the example presented above.

Although the aforedescribed ranking method removes some of the risk of potential re-identification of patients by setting a user-defined k-value, there remains still the possibility of re-identification, for example, because the k-value is too low. For this reason, a more realistic estimate of “safe” k-values may be obtained by interfacing the records with reference data sources, such as a voter registry, drivers' license records, etc. The de-identified data can the be tested against the reference data source and the k-values adjusted. This test can be performed by suitable software program which allows the removal (or encryption) of only as much information as is necessary to de-identify a given record within the entire collection of data that has passed through the program over the given time frame.

In a particular embodiment, the software program constructed to implement this method continuously maintains and updates a table of unique records from a stream of input data over time, as well as a count of the number of occurrences of each unique record identified within that stream of data over the same time period. Also included is the capacity to tally various record identifiers, such as unique person identifiers, within a collection of otherwise unique records, as might be required for systems that use such unique identifiers. In addition, the data that has been previously scrubbed out of records by encryption can be restored by decryption when sufficient additional data has passed through the data stream to render the scrubbed data no longer identifying.

For example, a data clearinghouse may buy personal claims data from multiple insurance companies and sell the combined data to pharmaceutical companies for marketing research. Regulations require that the data be de-identified prior to being sold. The clearinghouse would like to reduce the amount of data lost in the de-identification process, but delaying the sale would reduce the value of the data. The embodiment described above allows the clearinghouse to sell the data in a continuous stream, while providing information to the de-identification software based on all the data that had streamed through over a period of time, so that de-identification can be based on a much larger number of records without having to withhold those records from sale. In addition, the pharmaceutical companies receiving the de-identified data stream could, through access to the invention and the record table used to de-identify their data stream, recover data that had been removed through encryption early in the stream as additional data pass through the data stream sufficient to render the removed data no longer identifying. Finally, if the invention is used to create a single record table for several such clearinghouses, an even lower degree of data loss can be achieved.

In a further embodiment, the de-identification process described above may be used in conjunction with a biologic data sampling device, such as a DNA bio-assay chip (or “biochip”) or another high-speed data sampling system. A device according to this embodiment can be part of an instrument for the purpose of filtering the data output obtained from an analysis on genetic or biologic samples to ensure that the output conforms to the relevant patient privacy guidelines, e.g., HIPAA. Specifically, the device aggregates and “scrubs” the collected data (as the “data input source”) that individually or in combination would allow identification of individual patients while retaining as much information as possible relevant to the purpose of the analyses.

With this approach, analysis of biologic specimens yields a collection of results (e.g., polymorphisms, deletions, binding characteristics, expression patterns) that are used to distinguish one group of test subjects from another (e.g., those at greater risk of breast cancer from those at lower risk). The uses of such analyses are manifold, and include risk profiling, screening and drug-target discovery. For a given result to be relevant to an analysis seeking to distinguish two or more groups, its prevalence must differ significantly among the groups.

The de-identification devices described herein allow the information resulting from the analyses of biologic specimens to be aggregated prior to disclosure to researchers. Only selected results are outputted, using for example the k-anonymity algorithm described above, so that the relevant guidelines for de-identification are satisfied to a pre-selected level of de-identification.

The de-identification device may give highest priority to preserving in the output those results that occur significantly more frequently in one group than another, while suppressing (truncating) or encrypting individual results within a field or even entire fields that occur at a frequency outside a target range of useful frequencies within two or more groups. As already mentioned above, the device may store suppressed data in encrypted form instead of discarding them, so that as additional analyses are added, those encrypted data may be decrypted as the constraints of de-identification are satisfied, for example when the aggregate k-anonymity level crosses the minimum threshold.

In one example, a DNA array chip may perform a bioassay, for example a probe binding test, recording the results of the bioassay at many hundreds or thousands of sites on an individual DNA sample. For drug discovery purposes, a result is of interest only if it is statistically significant, i.e., the result is obtained significantly more frequently in one group of patients than in another. In addition, results tend to be of lesser value if they are either observed in all or nearly all of the patients or in so few patients that further analysis would not produce statistically significant results due to the small sample size.

A device according to this embodiment of the invention aggregates the results of multiple samples (as the input data source) and outputs only the minimum amount of data allowable by de-identification constraints while giving preference in the output to fields that differ with the greatest statistical significance. Those fields that differ with greatest significance between two or more groups are accordingly selected for the highest priority for preservation in the output. When additional samples are later analyzed, the device may decrypt previously fields that were previously truncated by encryption as the de-identification requirements are satisfied by a greater number of samples.

The aforedescribed methods are advantageously implemented in software. By analyzing an input data source (also referred to herein as a database or dataset), such as one containing patient records in a healthcare context, the software application determines which values in individual fields of the records result in a risk to the privacy of the patients who are the subject of the individual records. The application also collects statistics on those records presenting a risk to the patients' privacy (i.e., a risk of re-identification) and outputs a copy of the dataset with those values truncated (or “scrubbed”). Such scrubbing may consist of simple deletion or, alternatively, encryption and retention of the encrypted data in the resulting output dataset. The encrypted values can be later restored when an increased database record size makes re-identification less likely, thereby also possibly reducing the k-vale. The application may also attempt to match the patients of the dataset to a reference dataset (in one example, a voter registration or motor vehicle registry list) and collect statistics regarding the number of unique matches in order to test the resulting (post-processing) risk of re-identification. The software can then compute from attempted matches to the reference database the smallest k-value that prevents de-identification.

The k-anonymity value can also be defined based on the intended use of the data. For example, a very high level of protection is required for medical and psychological data, whereas income levels and consumer preferences may not require such enhanced protection so that a lower k-value may suffice.

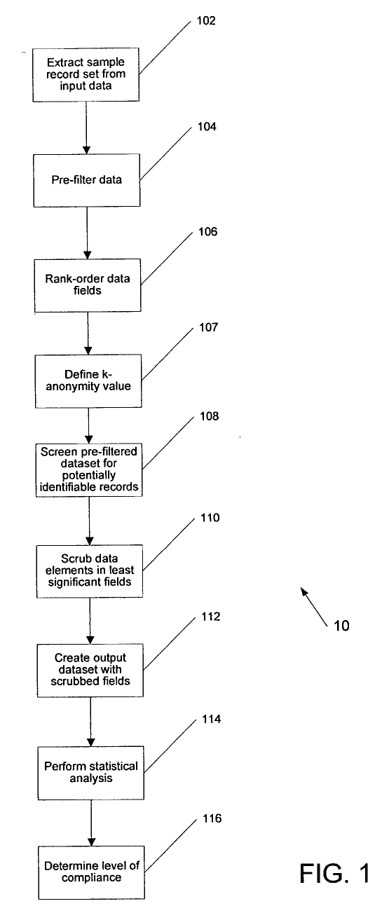

Referring now to FIG. 1, a process flow diagram 10 of a manual de-identification method begins in step 102, where the system source based on a query supplied by a user. The query may specify sample size, which fields to be included, as well as rank ordering of data fields and/or variables by importance to the end-user. Optionally, large datasets may be filtered prior to de-identification by extracting a more manageable query dataset.

In step 104, the process pre-filters the data by computing a limited number of restricted fields from the raw data to minimize data loss. For example, variables with many discrete values (such as a Zip Code field), could be truncated to yield a smaller number of larger regions. Also, for example, actual family income values can be aggregated into a few median family income categories. This functionality retains most of the value to the end-user, while dramatically reducing the rate of data degradation due to de-identification.

The fields in the dataset, or in the particular query data set, are then rank-ordered according to the perceived importance for the user, step 106. After defining a k-anonymity value in following step 107, the process screens the pre-filtered dataset for potentially identifiable records within the given k-value, as determined, for example, by an operator depending on the security environment of the end-user and set via an administrative user interface, which may itself be implemented via a conventional web browser interface, step 108. As mentioned above, different data categories may require different predefined k-values.

The process 10 then identifies in step 110 individual data elements in least significant fields that could result in a high risk of potential re-identification of patients. The potentially high-risk fields that result in a potential re-identification of patients using the predetermined k-value are then scrubbed, creating an output data file in a conventional format that is identical to the input query dataset except for the scrubbed data elements in the least significant field(s). Scrubbing shall refer in general to the process of deletion, truncation and encryption. In the case of encryption, the scrubbed data can be stored in a file and can be decrypted and reused when, for example, the size of the database increases, as mentioned above.

Next, in step 112, the process creates an output dataset that is identical to the input dataset, except that the process has scrubbed out the minimum necessary number of data elements, from the least vital fields in the dataset, to achieve the pre-selected k-anonymity.

Step 114 documents basic statistics on the number of fields, their rank, the number of records failing to meet k-anonymity, the number of records uniquely identifiable using public databases, the fraction of data elements scrubbed (or requiring scrubbing) to meet k-anonymity standards

Optionally, in step 116, the process may document the output dataset's level of compliance with selected privacy regulations given a specific security environment. This certification functionality may be performed on any dataset, either before or after processing according to the process 10 described above.

In the previous approach, the k-value is entered manually. In an alternative approach, the k-value can be determined and/or updated by linking the input data source to reference databases, for example, publicly available government and/or commercial reference databases including, but not limited to voter registries, state and federal hospital discharge records, federal census datasets, medical and non-medical marketing databases, and public birth, marriage, and death records. The quantitative measures include, in some embodiments, a measure of the number of unique records in the data source; a quantitative measured risk of positive identification of members within a data source using a defined set of reference public databases; and a measure of the gain in privacy protection that can be achieved through data source screening and/or scrubbing according to the methods of the invention.

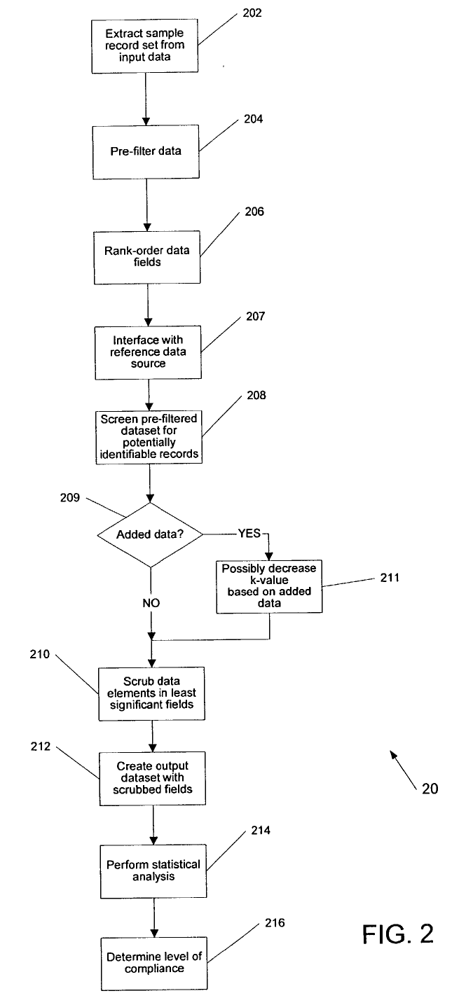

Referring now to FIG. 2, a process flow diagram 20 of a de-identification method linked to an outside reference database begins with step 202, which is identical to step 102 of process 10. In step 204, the process pre-filters the data, as before, and rank-orders the fields, step 206. In the following step 207, the process interfaces with a reference database and screens the pre-filtered dataset for potentially identifiable records based on the reference database, step, 208, and identifies those records that could be uniquely identified using the reference database by linking, for example, year of birth, month of birth, day of birth, gender, 3-digit Zip, 4-digit Zip and/or 5-digit Zip, or other fields common to both datasets. The process can then check in step 209, if data were added that could relax the k-value, step 211, as discussed above. The record can then be scrubbed or the initially selected value for k can be increased, meaning that more fields are aggregated, step 210. When more data are added to the input database, the process can optionally automatically check the enhanced input database against the reference database and decrease the value for k, without risking re-identification. Steps 212-216 of process 20 are identical to steps 112-116 of process 10.

In addition, generated reports with the statistical data listed above can be displayed and/or printed. An internal log file can be maintained listing output dataset names, user names, date and time generated, query string, statistics and MD5 signature, so that the administrator can later confirm the authenticity of a dataset.

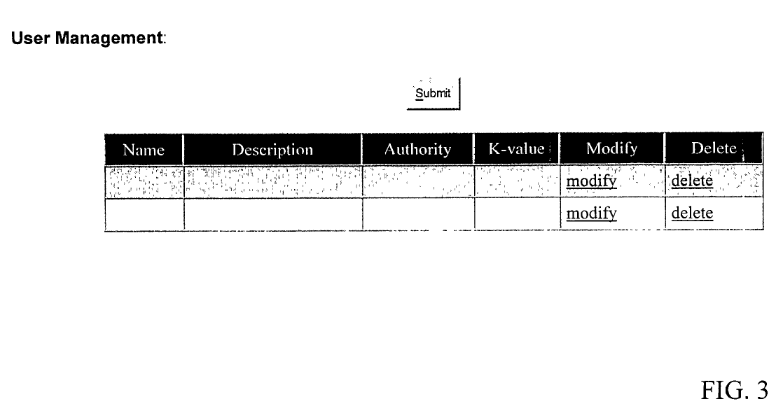

An application program or other form of computer instructions for implementing the above-described method can be organized as a set of modules each performing distinct functions in concert with the others. Such a program organization is known to those of ordinary skill in the relevant arts. Exemplary modules can include a web-based graphic user interface (GUI) indicated in FIG. 3 that allows user log in (Name) and user authentication (Authority, such as Administrator—specifying destination dataset for de-identification, etc.) as well as selection of a functional aspect of the system (such as setting a k-value and specifying modification and deletion of user information data), generally referred to as a data input. Other administrative functions may include setting encryption standard and/or keys, authorizing of deleting operators, and setting or changing global minimum k-anonymity levels for scrubbing operations.

An Interpretation Engine collects inputs from the above-described GUIs and passes query definitions and other parameters (e.g., the target k-anonymity value) to Scrub/Screen Engine which links to the input data source and related reference databases, and performs the requested screening and/or scrubbing functions. This engine also provides the output scrubbed dataset and related statistical reports and certification documents as commanded.

While web-based graphical interfaces are advantageously employed, one of ordinary skill in the art will appreciate that other user interfaces, including stand-alone workstation and/or text-based interfaces are also well-known in the art and readily adapted to use with this system. Accordingly, the invention is not limited by the type or nature of the operator or administrator interface.

The method of the present invention may be performed in either hardware, software, or any combination thereof, as those terms are currently known in the art. In particular, the present method may be carried out by software, firmware, or microcode operating on a computer or computers of any type, either standing alone or connected together in a network of any size. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. A method of record de-identification for use with a first data source having a plurality of first records having one or more first fields, said first fields having at least one corresponding first value, comprising:
prioritizing said first fields according to a user preference of a user;
using a second data source, wherein said second data source comprises a plurality of second records having one or more second fields, said second fields having at least one corresponding second value, comparing said first fields and said corresponding first values of each said first record to said second fields and said corresponding second values of all of said second records; and
based on said comparing, extracting said first records and said first corresponding values of the highest priority first fields from said first data source to a third data source, wherein said extracting results in a k-anonymity value for said third data source approximating a pre-defined k-anonymity value.

2. The method of claim 1, wherein said pre-defined k-anonymity value is selected by said user.

3. The method of claim 1, further comprising modifying said first data source prior to said comparing.

4. The method of claim 1, wherein said prioritizing further comprises measuring record uniqueness in said first data source.

5. The method of claim 1, further comprising measuring identification risk using said second data source and modifying said prioritizing accordingly.

6. The method of claim 5, further comprising displaying the change in said risk as said pre-defined k-anonymity value is varied by said user.

7. The method of claim 1, wherein said extracting is performed contemporaneously with said comparing.

8. The method of claim 1, wherein said extracting further comprises
copying said first records;
changing selected first corresponding values to form a plurality of modified records; and
storing said modified records in said third data source.

9. The method of claim 8, wherein said changing further comprises deleting one or more of said selected first values in one or more of said first fields and in one or more of said first records.

10. The method of claim 8, wherein said changing further comprises encrypting one or more of said selected first values in one or more of said first fields and in one or more of said first records.

11. The method of claim 1, wherein one or more of said prioritizing, comparing, and extracting are carried out over a computer network.

12. The method of claim 1, further comprising delivering all or selected portions of said third data source in electronic form.

13. The method of claim 1, wherein said pre-defined k-anonymity value is determined by measuring a re-identification risk using a reference database and modifying said pre-defined k-anonymity value accordingly.

14. The method of claim 13, further comprising automatically checking said re-identification risk when more data are added to the first data source, and decreasing the pre-defined k-anonymity value, if the re-identification risk decreases after addition of the data.

15. An apparatus for record de-identification, comprising:
a data capture system, wherein the data is placed in a first data source on capture, and wherein said first data source comprises a plurality of first records having one or more first fields, said first fields having at least one corresponding first value;
a reference data source comprising a plurality of second records having one or more second fields, said second fields having at least one corresponding second value;
comparison means for comparing said first fields and said corresponding first values of each said first records to said second fields and corresponding second values of all said second records;
a control interface to a user, operably coupled to said data capture system, said first data source, and said comparison means whereby:
said user pre-defines a resulting k-anonymity value for an output data source; and
said user prioritizes said first fields according to said user's preference for preservation; and
extraction means, operably coupled to said control interface and said output data source, for extracting the highest priority first fields from said first data source to said output data source based on said comparing;
wherein said extracting results in a k-anonymity value for said output data source that approximates said pre-defined k-anonymity value

16. The apparatus of claim 15, further comprising a biochip device coupled to said data capture system and providing the data captured thereby.

17. An apparatus for record de-identification for use with a first data source having a plurality of first records having one or more first fields, said first fields having at least one corresponding first value, comprising:
means for prioritizing said first fields according to a user preference;
using a second data source, wherein said second data source comprises a plurality of second records having one or more second fields, said second fields having at least one corresponding second value, means for comparing said first fields and said corresponding first values of each said first record to said second fields and said corresponding second values of all of said second records; and
based on said comparing, means for extracting said first records and said first corresponding values of the highest priority first fields from said first data source to a third data source, wherein said extracting results in a k-anonymity value for said third data source approximating a pre-defined k-anonymity value.

18. A computer system for use in record de-identification for use with a first data source having a plurality of first records having one or more first fields, said first fields having at least one corresponding first value, comprising computer instructions for:
prioritizing said first fields according to a user preference;
using a second data source, wherein said second data source comprises a plurality of second records having one or more second fields, said second fields having at least one corresponding second value, comparing said first fields and said corresponding first values of each said first record to said second fields and said corresponding second values of all of said second records; and
based on said comparing, extracting said first records and said first corresponding values of the highest priority first fields from said first data source to a third data source, wherein said extracting results in a k-anonymity value for said third data source approximating a pre-defined k-anonymity value.

19. A computer-readable medium storing a computer program executable by a plurality of server computers for use with a first data source having a plurality of first records having one or more first fields, said first fields having at least one corresponding first value, the computer program comprising computer instructions for:
prioritizing said first fields according to a user preference;
using a second data source, wherein said second data source comprises a plurality of second records having one or more second fields, said second fields having at least one corresponding second value, comparing said first fields and said corresponding first values of each said first record to said second fields and said corresponding second values of all of said second records; and
based on said comparing, extracting said first records and said first corresponding values of the highest priority first fields from said first data source to a third data source, wherein said extracting results in a k-anonymity value for said third data source approximating a pre-defined k-anonymity value.
